(19) United States
(12) Patent Application Publication
(10) Pub. No.: US 2005/0086042 A1
(43) Pub. Date: Apr. 21, 2005

(54) Parallel instances of a plurality of systems on chip in hardware emulator verification

(76) Inventor: Shiv Kumar Gupta, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/685,762

(22) Filed: Oct. 15, 2003

(51) Int. Cl. G06F 9/455

(52) U.S. Cl. 703/28

(57) ABSTRACT

Described herein are parallel instances of a plurality of systems on chip in a hardware emulator verification. Significant amount of product cycle time is saved by verifying systems on chip in a parallel fashion in contrast to serial fashion.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The complexity of systems on chip (SOC) continues to increase exponentially. As a result of tremendous amounts of integration of various systems, the verification process is increasingly time consuming. In fact, 50-70% of the time of a product cycle is consumed by the verification process, as opposed to the design.

Simulation is often used to verify SOCs through the use of test vectors and test patterns. However, with the increased complexity of SOCs, the amount of test vectors and test patterns also increase. In simulation, complete testing of all test patterns and test vectors required to verify an SOC can take months to years.

Many chip-makers now use a device called a hardware emulator to verify SOCs. A hardware emulator is a device with large amounts of logic and other circuitry with highly configurable connections. The connections can be configured so as to realize the design of the SOC. The design is usually described in a data structure. A script checks the capacity of the hardware emulator to determine whether the hardware emulator has sufficient logic and circuitry to realize the design described in the data structure. If the hardware emulator has sufficient capacity to realize the design described in the data structure, the script places the data structure in a top wrapper. The top wrapper parses the data structure describing the design and configures the hardware emulator to realize the design.

Hardware emulators provide an enormous speed advantage over other currently available verification processes. Hardware emulators provide speeds of as much as 50,000 times or even more than current simulations. However, hardware emulators are extremely expensive. As of date, hardware emulators can cost as much as US $10,000,000. Many chip-makers can only afford a few hardware emulators, if at all. As a result, many chip-makers queue SOCs for verification. While an SOC is spent in a queue, valuable time from the product cycle is lost.

Further limitations and disadvantages of conventional and traditional systems will become apparent to one of skill in the art through comparison of such systems with the invention as set forth in the remainder of the present application with reference to the drawings.

### BRIEF SUMMARY OF THE INVENTION

Aspects of the present invention are directed to parallel instances of a plurality of systems on chip in hardware emulator verification. In one embodiment, there is described a hardware emulator comprising a first circuitry, and second circuitry. The first circuitry is for verifying a first system on chip. The second circuitry is for verifying a second system on chip while verifying the first system on chip.

In another embodiment, there is described a hardware emulator for verifying a plurality of systems on chip. The hardware emulator comprises a first circuitry and a second circuitry. The first circuitry is configured to realize a first system on chip. The second circuitry is configured to realize a second system on chip while verifying the first system on chip. The second circuitry is connected to the first circuitry.

In another embodiment, there is described a method for verifying a plurality of systems on chip. The method comprises verifying a first system on chip with a first portion of a hardware emulator, and verifying a second system on chip with a second portion of the hardware emulator while verifying the first system on chip.

In another embodiment, there is described a computer readable medium storing a top wrapper for configuring a hardware emulator. The top wrapper comprises a first design structure and a second design structure.

In another embodiment, there is described a computer readable medium storing a data structure. The data structure comprises a first design structure and a second design structure. The first design structure comprises a first ports declaration, first design information, and an end of first design structure indicator. The second design structure comprises a second ports declaration, second design information, and an end of second design indicator. The second design structure immediately follows the end of first design structure indicator.

These and other advantages and novel features of the present invention, as well as details of illustrated embodiments thereof, will be more fully understood from he following description and drawings.

### BRIEF DESCRIPTION OF SEVERAL VIEWS OF THE DRAWINGS

FIG. 1A is a block diagram describing serial testing of systems of chip;

FIG. 1B is a block diagram describing parallel testing of systems on chip;

FIG. 2 is a block diagram of a hardware emulator configured in accordance with an embodiment of the present invention;

FIG. 3 is a block diagram describing a representative hardware environment wherein the present invention can be practiced;

FIG. 4 is a block diagram of an exemplary data structure in accordance with an embodiment of the present invention; and

FIG. 5 is a block diagram of an exemplary top wrapper in accordance with an embodiment of the present invention.

### DETAILED DESCRIPTION OF THE INVENTION

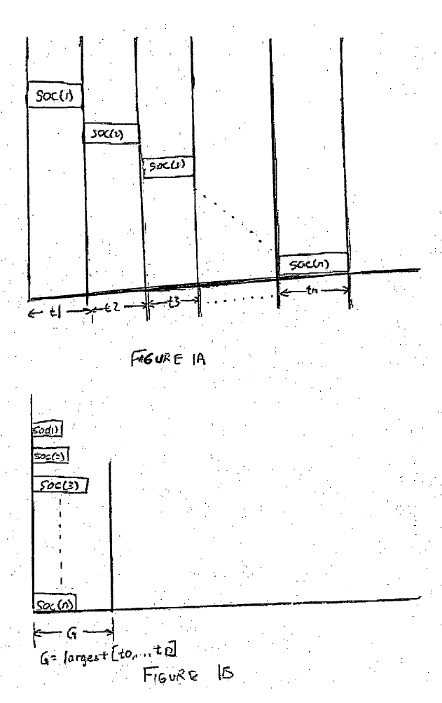

Referring now to FIG. 1A, there is illustrated a block diagram describing the verification of a plurality of systems on chip (SOC) SOC1 . . . SOCn in a serial manner. The SOCs SOC1 . . . SOCn are queued and verified one at a time. Accordingly, SOC1 is verified, followed by SOC2, followed by SOC3, through SOCn. The time required to test the SOCs SOC1 . . . SOCn is t1 . . . tn, respectively. Accordingly, the time required to verify the SOCs SOC1 . . . SOCn is described by the following equation:

$$Time = {\sum }_{K = 0}^{n} ( t k )$$

Referring now to FIG. 1B, there is illustrated a block diagram describing the verification of a plurality of SOCs SOC1 . . . SOCn in parallel. The SOCs SOC1 . . . SOCn are all verified at the same time. The time required to test all SOCs is the greatest of {t1, t2, t3, . . . tn}. The time savings is described by the following equation:

$$Time = {\sum }_{K = 0}^{n} ( t k ) - Greatest \{ t 1 , t 2 , t 3 , … t n \}$$

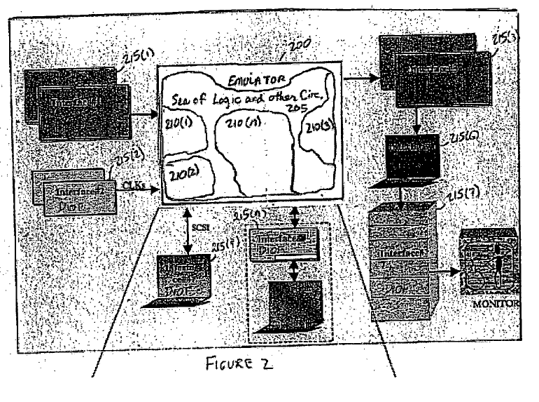

FIG. 2 is a block diagram of a hardware emulator configured in accordance with an embodiment of the present invention. The hardware emulator 200 comprises a sea of logic and other circuitry 205. The sea of logic and other circuitry 205 is configurable to realize a vast number of integrated circuits. The sea of logic and other circuitry can be divided into a plurality of portions 210. One portion 210(1) can be configured to realize a first SOC, SOC1. The second portion 210(2) can be configured to realize a second SOC, SOC2. Any number of portions 210(1) . . . 210(n) can be configured to realize any number of SOCs, SOC1 . . . SOCn, respectively, provided that the total logic and other circuitry of all of the SOCs, SOC1 . . . SOCn does not exceed the amount of logic and other circuitry in the seal of logic and other circuitry 205. After each portion 210(1) . . . 210(n) is configured to realize a SOC, SOC1 . . . SOCn, each of the SOCs can be verified simultaneously, or in parallel.

The emulator 200 is operably connected to a plurality of distal input/output interfaces (DIOF) 215(1) . . . 215(n). Each DIOF 215(1) . . . 215(n) is associated with a particular SOC, SOC1 . . . SOCn, and a portion of the sea of logic 210(1) . . . 210(n), respectively. Each DIOF 215(1) . . . 215(n) provides inputs to and receives outputs from the portion of the sea of logic 210(1) . . . 210(n), associated therewith. The inputs are test vectors and test patterns for the SOCs realized by the portions of the sea of logic 210 associated with the DIOFs 215. The outputs received by the DIOFs 215 can be used to verify the SOC realized by the portion of the sea of logic and other circuitry 205 associated with the DIOF 215.

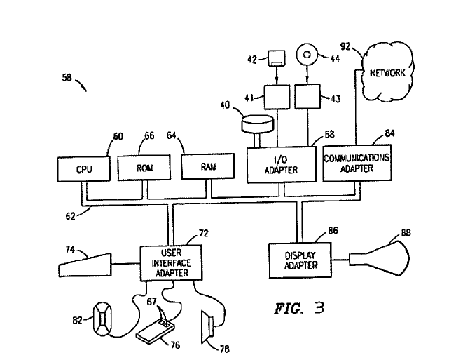

Referring now to FIG. 3, a representative hardware environment for a computer system 58 for practicing the present invention is depicted. A CPU 60 is interconnected via system bus 62 to random access memory (RAM) 64, read only memory (ROM) 66, an input/output (I/O) adapter 68, a user interface adapter 72, a communications adapter 84, and a display adapter 86. The input/output (I/O) adapter 68 connects peripheral devices such as hard disc drives 40, floppy disc drives 41 for reading removable floppy discs 42, and optical disc drives 43 for reading removable optical disc 44 (such as a compact disc or a digital versatile disc) to the bus 62. The user interface adapter 72 connects devices such as a keyboard 74, a mouse 76 having a plurality of buttons 67, a speaker 78, a microphone 82, and/or other user interfaces devices such as a touch screen device (not shown) to the bus 62. The communications adapter 84 connects the computer system to a data processing network 92. The display adapter 86 connects a monitor 88 to the bus 62. An embodiment of the present invention can be implemented as a file resident in the random access memory 64 of one or more computer systems 58 configured generally as described in FIG. 3. Until required by the computer system 58, the file may be stored in another computer readable memory, for example in a hard disc drive 40, or in removable memory such as an optical disc 44 for eventual use in an optical disc drive 43, or a floppy disc 42 for eventual use in a floppy disc drive 41.

The emulator 200 of FIG. 2 can be configured by a computer system configured generally as described in FIG. 3. An SOCs, SOC1 . . . SOCn can be described in a data structure in a file. The file is parsed by a script. A script is a plurality of executable instructions stored in the memory of the computer system, or a removable memory, that parses the data structures, checks the capacity of the emulator 200, and creates another file, known as a top wrapper. The top wrapper is provided to the emulator and configures the emulator 200 in accordance with the SOCs described in the data structure.

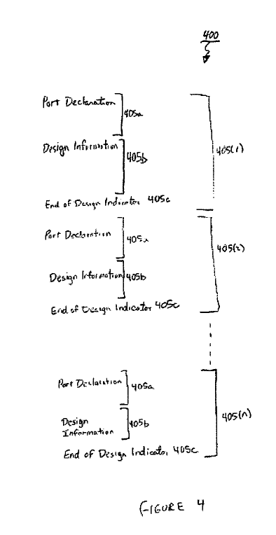

Referring now to FIG. 4, there is illustrated a block diagram describing an exemplary data structure in accordance with an embodiment of the present invention. The data structure 400 comprises a plurality of design structures 405(1) . . . 405(n). Each design structure 405(1) . . . 405(n) is associated with a particular SOC, SOC(1) . . . SOC(n), respectively. The design structures 405(1) . . . 405(n) describe the particular SOC, SOC(1) . . . SOC(n), associated therewith. Each design structure 405 comprises a ports declaration 405a and design information 405b, describing the ports and design of the SOC associated therewith. Each design structure 405 is terminated by an indicator 405c indicating the end of the design structure. Each indicator 405c(1) . . . 405c(n-1), is followed by another design structure 405(2) . . . 405(n), except the last indicator 405c(n).

The data structure 400 is parsed by the script. The script, checks the capacity of the emulator 200, and creates another file, known as a top wrapper. The top wrapper is provided to the emulator and configures the emulator 200 in accordance with the SOCs described in the data structure.

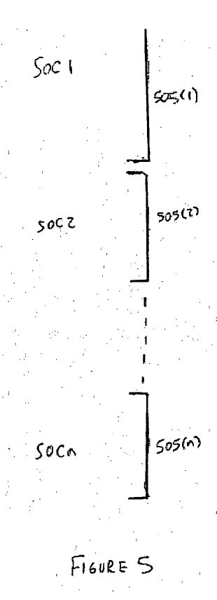

Referring now to FIG. 5, there is illustrated a block diagram of an exemplary top wrapper 500 in accordance with an embodiment of the present invention. The top wrapper 500 can be provided to an emulator 200 causing the emulator to realize SOCs described therein. The top wrapper 500 comprises a plurality of portions 505(1) . . . 505(n). Each portion is associated with a particular SOC, SOC1 . . . SOCn. When the top wrapper 500 is provided to the emulator 200, the portions 505(1) . . . 505(n), configure the portions of the sea of logic and additional circuitry 210(1) . . . 210(n) to realize the SOCs, SOC1 . . . SOCn associated therewith.

When the emulator 200 is configured to realize the SOCs SOC1 . . . SOCn, each of the SOCs, SOC1 . . . SOCn can be verified simlultaneously. The test vectors and test patterns are provided to the emulator for each SOC, SOC . . . SOCn via the associated DIOF.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A hardware emulator for verifying a plurality of systems on chip, said emulator comprising:
a first circuitry for verifying a first system on chip; and
a second circuitry for verifying a second system on chip while verifying the first system on chip.

2. The hardware emulator of claim 1, further comprising:
a first interface for providing inputs to the first circuitry and receiving outputs from the first circuitry; and
a second interface for providing inputs to the second circuitry and receiving outputs from the second circuitry.

3. The hardware emulator of claim 1, wherein the first circuitry is configured to realize the first system on chip and the second circuitry is configured to realize the second system on chip.

4. A hardware emulator for verifying a plurality of systems on chip, said emulator comprising:
a first circuitry configured to realize a first system on chip; and
a second circuitry configured to realize a second system on chip while verifying the first system on chip, the second circuitry connected to the first circuitry.

5. The hardware emulator of claim 4, further comprising:
a first interface operably connected to the first circuitry, wherein the first interface provides inputs to the first circuitry and receives outputs from the first circuitry; and
a second interface operably connected to the second circuitry, wherein the second interface provides inputs to the second circuitry and receives outputs from the second circuitry.

6. A method for verifying a plurality of systems on chip, the method comprising:
verifying a first system on chip with a first portion of a hardware emulator; and
verifying a second system on chip with a second portion of the hardware emulator while verifying the first system on chip.

7. The method of claim 6, further comprising:
configuring the first portion of the hardware emulator to realize the first system on chip; and
configuring the second portion of the hardware emulator to realize the second system on chip.

8. The method of claim 7, wherein configuring the first portion of the hardware emulator comprises receiving a portion of a top wrapper describing the first system on chip and wherein configuring the second portion of the hardware emulator comprises receiving another portion of a top wrapper describing the second system on chip.

9. The method of claim 6, wherein verifying the first system on chip further comprises:
providing inputs to the first portion; and
receiving outputs from the first portion.

10. A computer readable medium storing a top wrapper for configuring a hardware emulator, the top wrapper comprising:
a first design structure for describing a first system on chip; and
a second design structure for describing a second system on chip.

11. A computer readable medium storing a data structure, the data structure comprising:
a first design structure for describing a first system on chip, wherein the first design structure further comprises:
a first ports declaration for describing ports associated with the first system on chip;
a first design information for describing at least a portion of the first system on chip; and
an end of first design structure indicator, for indicating the end of the first design structure; and
a second design structure for describing the second system on chip, wherein the second design structure further comprises:
a second ports declaration for describing ports associated with the second system on chip;
a second design information for describing at least a portion of the first system on chip; and
an end of second design structure indicator, for indicating the end of the second design indicator; and
the second design structure immediately following the end of first design structure indicator.
